(19) United States
(12) Patent Application Publication
(10) Pub. No.: US 2025/0043669 A1
(43) Pub. Date: Feb. 6, 2025

(54) A METHOD OF SYNGAS PRODUCTION AND A SYSTEM FOR USE IN SYNGAS PRODUCTION

(71) Applicant: Timothy PARSONS, Kingston Upon Thames Surrey (GB)

(72) Inventor: Timothy PARSONS, Kingston Upon Thames Surrey (GB)

(21) Appl. No.: 18/717,750

(22) PCT Filed: Dec. 1, 2022
(86) PCT No.: PCT/GB2022/053043

§ 371 Date: Jun. 7, 2024

(30) Foreign Application Priority Data
Dec. 8, 2021 (GB) 2117745.6

(51) Int. Cl. E21B 43/243; E21B 43/24; E21B 43/38

(52) U.S. Cl. CPC E21B 43/243; E21B 43/2401; E21B 43/38

(57) ABSTRACT

There is a method for producing syngas from a hydrocarbon bearing rock formation. The method has the steps of advancing a heating device through a well in the hydrocarbon bearing rock formation to an underground location within the hydrocarbon bearing rock formation and activating the heating device at the underground location to heat the hydrocarbon bearing rock formation to produce syngas. Advancing the heating device has the step of advancing a control line coupled to the heating device through the well. There is also a method of producing hydrogen. The method has the steps of producing syngas and filtering the syngas to extract hydrogen. There is also a heating system for producing syngas from a hydrocarbon bearing rock formation. The heating system has the components of a heating device passable through a well in the hydrocarbon bearing rock formation to an underground location within the hydrocarbon bearing rock formation and actuatable at the underground location to heat the hydrocarbon bearing rock formation to produce syngas and a control line coupled to the heating device.

### FIELD OF THE DISCLOSURE

The present disclosure relates to syngas production, particularly, but not exclusively, syngas production in a well.

### DESCRIPTION OF THE RELATED ART

Typically, syngas is around 30 to 60% carbon monoxide (CO), 25 to 30% hydrogen (H2), 0 to 5% methane (CH4), 5 to 15% carbon dioxide (CO2), and some water vapor, sulphur compounds including hydrogen sulphide (H₂S) and carbonyl sulphide (COS), and finally some ammonia and other trace contaminants.

Syngas containing hydrogen can be produced from oil wells by pumping steam down the wells and collecting the syngas produced by the heating of the hydrocarbons in the rocks surrounding the wells. Using this method requires heavy, large and expensive equipment and a large amount of energy.

### SUMMARY OF THE DISCLOSURE

There is provided a method of producing syngas from a hydrocarbon bearing rock formation, the method comprising: advancing a heating device through a well in the hydrocarbon bearing rock formation to an underground location within the hydrocarbon bearing rock formation; and activating the heating device at the underground location to heat the hydrocarbon bearing rock formation to produce syngas.

The heating of the hydrocarbon bearing rock formation may cause pyrolysis, gasification and/or combustion of hydrocarbons in the rock formation. The heating of the hydrocarbon bearing rock formation may cause water in the well to produce syngas via gasification.

Gasification of the water may also be referred to as water-gas shift and/or aquathermolysis.

Activating the heating device once it is at the underground location is more efficient than transporting a heat source (such as steam) through the well to the underground location. Further, by generating heat at the well bottom, possible leaks caused by heat from the surface which could cause damage to casing and cement in the well can be avoided.

This method is also inexpensive and lightweight and could be run without the need of an oil rig on the well. The method may be used offshore or onshore and is less expensive than a steam rig-up which requires heavy pumps and compressors. The present invention requires less deck space on an offshore rig and the equipment required is lightweight so may be helicopter-transportable meaning that no expensive supply boats or heavy crane-lifts are required.

The method may be deployed quickly and can be used in most oil or gas wells in the world. The hydrogen produced can be pumped down existing pipelines to shore, either on its own, or mixed with existing gas production. For example, 15% to 50% Hydrogen may be added or blended into gas pipelines. The hydrogen produced may be used for Ammonia production through the Haber Bosch process and the hydrogen or syngas produced can be used to drive engines (see JCB and Caterpillar hydrogen engine prototypes).

The underground location may be deep underground. The depth provides seals (impermeable cap-rock) barriers to surface so that gasses remain in the well (especially CO2) and in-situ combustion can be controlled and even extinguished (because the combustion is in a sealed rock and not open to oxygen unlike coal seam fires). The underground location may be a sealed combustion chamber.

Advancing the heating device may comprise advancing a control line coupled to the heating device through the well.

In other embodiments, the heating device may be advanced through the well without a control line.

The control line may comprise one or more tubes. The tube(s) may be encapsulated in the upper portion depending on temperature limits, for example in a plastic-like material such as polypropylene or “ECA-3000” as manufactured by Prysmian Group or other materials as manufactured by Sandvik or Hydrasun control line manufacturers and the encapsulation may include bumper bars for added strength per the Prysmian “flatpack” designs. This may provide extra strength and can accommodate multiple tubes or wires as part of the control line. Using an encapsulated control line as the tube to inject gasses (oxy/air) means that it is stronger which allows a heavier weight to be run on the control line. Further the control line can be bent over a sheave without bending and collapsing. The sheave may have a diameter that is 60× the diameter of the control line.

Each tube may provide a passage. The control line may comprise a fluid supply passage for passing fluid to or from the underground location and/or a gas vent or injection passage for injecting or collecting gas from the underground location and/or an electricity supply passage housing a conductor. Having a gas vent passage is advantageous as this means that the produced gas can be quickly and easily collected from the same well that is being heated.

The control line may comprise an inner tube within an outer tube such that the control line provides a first passage through the inner tube and a second passage through an annulus formed inside the outer tube, and outside of the inner tube. The control line may comprise further tubes and/or annuli. Gas or electricity may be supplied to the underground location through the first passage and gas may pass from the underground location through the second passage. Alternatively, gas or electricity may be supplied to the underground location through the second passage and gas may pass from the underground location through the first passage.

Each of the tubes and/or passages may convey a fluid or a gas or one or more electric cables. Multiple passages allows conveyance of more than one type of wire or gas and may allow recovery of wire for example. The gas may be oxygen, air, syngas, hydrogen, mercury, an inert gas and/or another gas or fluid.

The method may further comprise supplying a gas such as air, oxygen and/or other gasses to the underground location via the control line when the heating device is activated or after the heating device is activated. The gas may continue to be supplied while the heating device is producing heat and/or may be stopped and re-started to control the temperature of the underground location. The gas supply may maintain activation and/or combustion of the heating device. The heating operation may be cyclic.

An inert gas may be supplied via a tube or passage in the control line. This may allow for extinguishing of combustion in the underground location.

A passage of the control line may house an electrical conductor. The electrical conductor may be a wire or a conducting fluid, such as mercury. The method may comprise transmitting electric current to the heating device via the conductor.

The method may comprise detecting a temperature of the underground location by monitoring the nature of the mercury. The mercury may provide hydrostatic head, for example to keep a filter in place. A spacer fluid or barrier may be located between the mercury and the heating device. This may prevent the mercury from boiling.

An outer diameter of the control line may be of any size that fits the existing tubing or casing in the well, For example, less than 8.9 cm or less than 7.3 cm. In this way, the control line may be inserted in the production tubing of existing oil wells. This tubing may be 3½″ outside diameter but could be any size.

The control line may be mounted on a spool coupled to an anchor. The anchor may be a base filled with water. This adds weight to the spool assembly and prevents the control line spool being moved by the weight of the string in the well. For example, a spool of control line may be mounted on a pick-up truck. 10,000 feet of control line weighs about a ton and has quite enough collapse and burst resistance to well pressures.

The control line may have a melting point above 1,000 C. The control line may have a melting point above the temperature produced by the heating device at the underground location.

The fluid supply passage of the control line may comprise a one-way valve. This may prevent backflow of fluid passed to the underground location. This may also provide buoyancy if a heavy weight is suspended on the control line.

The heating device may be coupled to flexible fins extending radially outwards and advancing the heating device through the well may comprise pumping fluid into the well behind the fins to urge the heating device through the well towards the underground location. The use of pumping may overcome resistance caused by friction and/or contamination build up in the well.

This will also keep tension on the control line. The control line may be referred to as a string. The tension helps to avoid string-buckling. The fins may be attached directly to the heating device or to another component such as a heat shield. The fin may be sacrificial. The fin may have a melting and/or combustion point below the maximum temperature produced by the heating device. The fins may open and close according to the width of the well annulus.

The method may further comprise maintaining the pressure of the fluid pumped below a threshold. This may avoid damaging the control line with high pressure or causing the heating device to be parted from the control line.

The fluid pumped may also serve as a heat insulator to keep hot gasses and energy in the underground location and prevent heat escaping up to surface. Different types of fluids may be used such as brine or water or oil based muds and these fluids may be circulated in and out of the well so as to change them as required.

The method may further comprise determining when the heating device is at the underground location by monitoring the pressure of the fluid and detecting a decrease in pressure when the fins exit the tubing, indicative of the heating device being located at the underground location.

The method may further comprise determining when the heating device is at the underground location by monitoring the volume of fluid pumped. For example, the method may comprise using a stroke-counter on the pump to indicate device position in the well.

Activating the heating device may comprise supplying electricity to the heating device via an electrical conductor in the control line.

Supplying electricity may comprise using a conductor in a passage of the control line, the conductor connected to an electricity supply at the surface and the heating device at the underground location. A wire may be located inside or outside a tube of the control line. A wire may be incorporated in the encapsulation material of the control line.

Alternatively, the heating device may be connected to a battery and electricity may be supplied to the heating device from the battery.

The method may comprise drawing gas generated by the heated rock formation through a passage in the control line. The method may comprise drawing gas generated by the heated rock formation through one or more secondary wells. Drawing the gas may comprise using a vacuum. Fluid may be pumped between the heated well and, or the secondary well(s) to assist dissipation of heat. Secondary wells may be referred to as production wells. Hot water produced may be separated and run through a heat-exchanger to drive a turbine and generate energy or electricity.

The control line may pass through a lubricator, the lubricator to forming a pressure seal between the well and the outside environment. The lubricator may have one or more packoff(s) or other seals that maintains this pressure seal. The lubricator may have a quick connection to the wellhead common to the oil industry. The lubricator may be of any diameter. A custom-made adaptor spool or flange may be fitted between the lubricator and the wellhead or the well casing or tubing in the case of an absence of a wellhead on an old well. The control line may be terminated in the wellhead or the adaptor spool to allow removal of the lubricator and connection to surface pressure equipment or gas separation and processing equipment.

In this way, the wellhead valve can be closed to isolate the lubricator as a separate chamber for example, for pressure testing or while inserting the device into the lubricator if the well was under pressure. The lubricator may be high pressure (for example, 1,000-10,000 psi and a cylinder about 6″-12″ diameter and up to 40 foot long) and pressure tested. This would allow the conveying of the heating device without having to “kill the well” because the lubricator acts as a fluid-lock. In this way, the well can be opened and the lubricator holds the pressure of the well. This lubricator is common to oil well workover and wireline operations for many years.

One or more packoffs or other seals at the surface may be used to seal wellbore fluids and gasses inside the well while moving the control line up or down the well.

A blowout preventer (BOP) may be located below the lubricator and above the wellhead to allow addition of extra lengths of control line in the event that very long strings were required. The BOP may ram seal or annular seal the wellbore around the control line and “slips” incorporated to support the weight of the control line while pressure in the lubricator was bled off, the lubricator removed and a connector installed to add the extra length on the spool to the length in the well.

Remote tools may be located on the bottom of the control line. The remote tools may be activated by a known means used for deep-water drilling, for example, acoustics, sonics or pulses transmitted in the wellbore fluid cause by varying pump rates similar to those used in operating directional drilling assemblies common to the oil industry.

These remote tools may also be operated by mechanical or other means.

A heat shield may be provided above the heating device.

The heat shield may comprise a ceramic or other material. This keeps the heat concentrated on the rock and reduces the heat escaping back up the well annulus. The heat shield may allow gas to pass through it, but at least partially block heat transfer.

The heat shield assembly may incorporate a system for channelling or venting fluid up one of the control line tubes by opening a valve at surface or remote control downhole to extract heat from the well and this hot fluid may be run through a heat-exchanger to produce energy, with the waste fluid being re-injected or disposed of. Hot water or gasses vented up secondary wells may also be run through a heat-exchanger and used to generate geothermal energy.

The heat shield may allow expansion and contraction around the internal circumference of the well. The heat shield may incorporate a buffer on which a block of Bismuth or other metal of any shape and length may be gravity deployed, dropped or forced down by pumping so that it seats on the heat shield and melts forming a seal in the wellbore, further sealing the bottom of the well. This buffer may be further up the well above the heat shield.

There is further provided a method of producing hydrogen, the method comprising: producing syngas using a method of any one of the preceding claims, and filtering the syngas or passing it through a membrane to extract hydrogen.

Filtering may comprise using a catalyst, for example a palladium catalyst.

Filtering may take place at the underground location or at the surface. The filtered syngas may be reinjected into the rock formation.

Filtering the syngas to extract hydrogen may be preceded by running a filter from the surface to the underground location by hydraulic or mechanical means. The filter may be secured in position at the underground location. For example, securing the filter may comprise latching the filter to a receptacle or filter housing. Furthermore, the method may comprise retrieving the filter from the underground location by hydraulic or mechanical means. The filter may be retrieved after producing hydrogen. For example, the filter may be retrieved and replaced by a new filter to carry out maintenance of the filter.

The method may be expressed as a method of filtering gas downhole where the filter or membrane can be run and retrieved from surface by hydraulic or mechanical means and latched in place and released for changing by hydraulic or mechanical means.

The method may further comprise using a receptacle with an inner cartridge containing one or more filters or membranes to filter the syngas. The cartridge in the receptacle may latched and recovered by mechanical or hydrostatic means as a run-and-retrieve filter. This means that the filter may be changed as required and the filter(s) can be changed from surface without pulling the string. The receptacle may be coupled to the gas vent passage.

The method may comprise choking, separating and/or controlling gasses using a high-pressure system at the surface. Hydrogen or other gas may be kept under pressure at surface to aid compression for storage in tanks or bottles or to aid separation of various gasses if membranes require higher than ambient pressures and temperatures.

The heating system may further comprise a surface gas separation system which filters the gas collected by the gas vent passage. The system may also include a software evaluation system which calculates the composition of the syngas produced from monitored parameters in the well.

The heating device may comprise a fuel and wherein igniting the heating device comprises igniting the fuel. The fuel may be thermite. The heating device may comprise an initiator. The initiator may be a magnesium strip which may be ignited by friction or electric charge. Activating the heating device may comprise beginning combustion of the heating device.

The fuel may be ignited remotely from the surface by a trigger. The trigger may be mechanical and may be dropped or pumped or by actuated by other remote means, for example pump activated, electrical or sonic activation or by battery operation.

The heating device may comprise an electric heating device, such as a microwave, dielectric, electromagnet, a radiofrequency antenna and/or ohmic device. A dielectric heating device may produce electromagnetic radiation. Ohmic heating may produce temperatures of around 200 and 800° C. or between 40° and 700° C. The heating device may comprise an oxidizing-agent injector, or a hot material injector. The heating device may be an electric heater, for example, a screw plug heater, a flanged heater, a tubular heater, a cartridge heater.

The heating device may produce temperatures between 250 and 1,000 C, for example, 760 C (1,400 F) or higher.

The heating device may further comprise a temperature controller or a thermocouple to measure temperature or a temperature regulator.

Advancing the heating device may comprise lowering the heating device into the well under gravity.

The underground location may be a void which may be under-reamed to a larger diameter than the original well and above the base of the well. The void may run from a casing “shoe” of the well annulus to the well bottom or may be just a portion of the open hole section.

The method may comprise enlarging the underground location using an under-reamer. The under-reamer may comprise cutters that extend outwards when activated and cut a bigger diameter hole under the casing shoe.

This may allow use of a larger heating device. The heating device may comprise element components that spring out or are forced to expand by dropping or pumping down a ball, bar or other initiator once the device reaches the underground location to provide an array of heating elements. Under-reaming could also be useful if debris build up (i.e., coke or ash) was a problem and more space was needed in the underground location.

There is further provided a heating system for producing syngas from a hydrocarbon bearing rock formation, the heating system configured to carry out a method as described above.

There is further provided a heating system for producing syngas from a hydrocarbon bearing rock formation, the heating system comprising: a heating device passable through a well in the hydrocarbon bearing rock formation to an underground location within the hydrocarbon bearing rock formation; and actuatable at the underground location to heat the hydrocarbon bearing rock formation to produce syngas.

The heating system may further comprise a control line coupled to the heating device. The control line may comprise one or more tubes. The tube(s) may be encapsulated, for example in a plastic-like material.

The heating system may further comprise a sheave, over which the control line passes. The sheave may have a diameter that is 60× the diameter of the control line.

Each tube may provide a passage. The control line may comprise a fluid supply passage for passing fluid to the underground location and/or a gas vent passage for collecting gas from the underground location and/or an electricity supply passage housing a conductor.

The control line may comprise an inner tube within an outer tube such that the control line provides a first passage through the inner tube and a second passage through an annulus formed inside the outer tube, and outside of the inner tube. The control line may comprise further tubes and/or annuli. The first passage may be configured to supply gas and/or electricity to the heating device and the second passage may be configured to pass gas from an end of the passage proximal the heating device, to an opposite end of the passage. Alternatively, the second passage may be configured to supply gas and/or electricity to the heating device and the first passage may be configured to pass gas from an end of the passage proximal the heating device, to an opposite end of the passage.

Each of the tubes and/or passages may be configured to convey a fluid such as a gas or one or more electric cables. Multiple passages allows conveyance of more than one type of wire or gas and may allow recovery of wire for example. The gas may be oxygen, air, syngas, hydrogen, mercury, an inert gas and/or another gas or fluid.

The heating system may be configured to supply a gas such as air, oxygen and/or other gasses to the underground location via the control line when the heating device is activated or after the heating device is activated. The gas may continue to be supplied while the heating device is producing heat and/or may be stopped and re-started to control the temperature of the underground location. The gas supply may maintain activation and/or combustion of the heating device.

The heating system may be configured to supply inert gas via a tube or passage in the control line. This may allow for extinguishing of combustion in the underground location.

A passage of the control line may house an electrical conductor. The electrical conductor may be a wire or a conducting fluid, such as mercury.

The heating system may be configured to detect a temperature of the underground location by monitoring the nature of the mercury. The mercury may provide hydrostatic head, for example to keep a filter in place. A spacer fluid or barrier may be located between the mercury and the heating device. This may prevent the mercury from boiling.

An outer diameter of the control line may be less than 8.9 cm or less than 7.3 cm. In this way, the control line may be inserted in the production tubing of existing oil wells. It may also be another size.

The heating system may comprise a spool coupled to an anchor on which the control line may be mounted. The anchor may be a base filled with water.

The control line may have a melting point above 1,000 C. The control line may have a melting point above the temperature produced by the heating device at the underground location.

The fluid supply passage of the control line may comprise a one-way valve. This may prevent backflow of fluid passed to the underground location.

The heating system may further comprise a flexible fin coupled to the heating device, the fin extending radially outwards. The fin may be attached directly to the heating device or to another component such as a heat shield. The fin may be sacrificial. The fin may have a melting and/or combustion point below the maximum temperature produced by the heating device. The fin may be configured to open and close according to the width of the well annulus.

The heating system may be configured to monitor the pressure of the fluid and detecting a decrease in pressure indicative of the heating device being located at the underground location.

The heating system may be configured to determine when the heating device is at the underground location by monitoring the volume of fluid pumped.

Activating the heating device may comprise supplying electricity to the heating device via an electrical conductor in the control line.

Supplying electricity may comprise using a conductor in a passage of the control line, the conductor connected to an electricity supply at the surface and the heating device at the underground location. A wire may be located inside or outside a tube of the control line. A wire may be incorporated in the encapsulation material of the control line.

Alternatively, the heating system may comprise a battery connected to the heating device the battery configured to supply electricity to the heating device.

The heating system may further comprise the lubricator at surface, the lubricator configured to form a pressure seal between the well pressure or the well annulus and the outside environment.

The heating system may further comprise the packoff(s) at the surface, the packoff(s) configured to seal wellbore fluids and gasses inside the well while moving the control line up or down the well.

The heating system may further comprise the blowout preventer (BOP) located below the lubricator and above the wellhead. to allow addition of extra lengths of control line in the event that very long strings were required. The BOP may ram seal or annular seal the wellbore around the control line and “slips” may be incorporated to fit the BOP housing or wellhead or lubricator adaptor spool to support the weight of the control line while pressure in the lubricator was bled off, the lubricator removed and a connector installed to add the extra length on the spool to the length in the well.

The heating system may further comprise remote tools located on the bottom of the control line. The remote tools may be activatable by a known means used for deep-water drilling, for example, acoustics or sonics.

The heating system may further comprise a heat shield provided above the heating device and the control line. The heat shield may comprise a ceramic or other material.

This keeps the heat concentrated on the rock and reduces the heat escaping back up the well annulus.

The heating system may comprise a filter or membrane configured to separate hydrogen from syngas. The filter may comprise a palladium catalyst. The filter may be located on or inside the control line, at the heating device or at the surface. The heating system may be configured to reinject syngas or waste fluids back into the rock formation.

The heating system may comprise a receptacle with a cartridge containing one or more filters to filter the syngas. The cartridge may be run from surface and latched into the receptacle and then unlatched and recoverable by mechanical or hydrostatic means.

This means that the filter may be changed as required and the filter(s) can be changed from surface without pulling the string. The receptacle may be coupled to the gas vent passage.

The heating system may comprise a high-pressure system at the surface configured to choke, separate and/or control gasses.

The heating device may comprise a fuel and which may be ignitable and/or combustible. The fuel may be thermite. The heating device may comprise an initiator.

The initiator may be a magnesium strip which may be ignited by friction or electric charge.

The heating system may comprise a trigger at the surface, the trigger configured to remotely ignite the heating device. The trigger may be mechanical and may be dropped or pumped or by actuated by other remote means, for example pump activated, electrical or sonic activation or by battery operation.

The heating device may comprise an electric heating device, such as a microwave, dielectric, electromagnet, a radiofrequency antenna and/or ohmic device. A dielectric heating device may produce electromagnetic radiation. Ohmic heating, may produce temperatures of around 200 and 800° C. or between 40° and 700° C. The heating device may comprise an oxidizing-agent injector, or a hot material injector. The heating device may be an electric heater, for example, a screw plug heater, a flanged heater, a tubular heater, a cartridge heater.

The heating device may be configured to produce temperatures of 760 C (1,400 F) or higher. The heating system may further comprise a temperature controller.

The heating device may comprise element components that spring out once the device reaches the underground location to provide an array of heating elements.

Further features and advantages of the above described aspects of the present disclosure will become apparent from the claims and the following description. The methods and systems described above may be combined in any possible combination.

The optional features described above are equally applicable to all of the described methods and systems and are not limited to the particular method/system with which they are described here.

### BRIEF DESCRIPTION OF THE DRAWINGS

Embodiments of the present disclosure will now be described by way of example only, with reference to the following diagrams, in which:—

FIG. 1 is a sectional side view of a heating system in a well;

FIG. 2 is a schematic diagram of part of a well pattern including the well of FIG. 1;

FIG. 3 is a top view of the well pattern of FIG. 2;

FIG. 4 is a perspective view of a selection of control lines.

### DETAILED DESCRIPTION OF THE DISCLOSURE

A number of different embodiments of the disclosure are described subsequently. In order to minimise repetition, similar features of the different embodiments are numbered with a common two-digit reference numeral and are differentiated by a third digit placed before the two common digits. Such features are structured similarly, operate similarly, and/or have similar functions unless otherwise indicated.

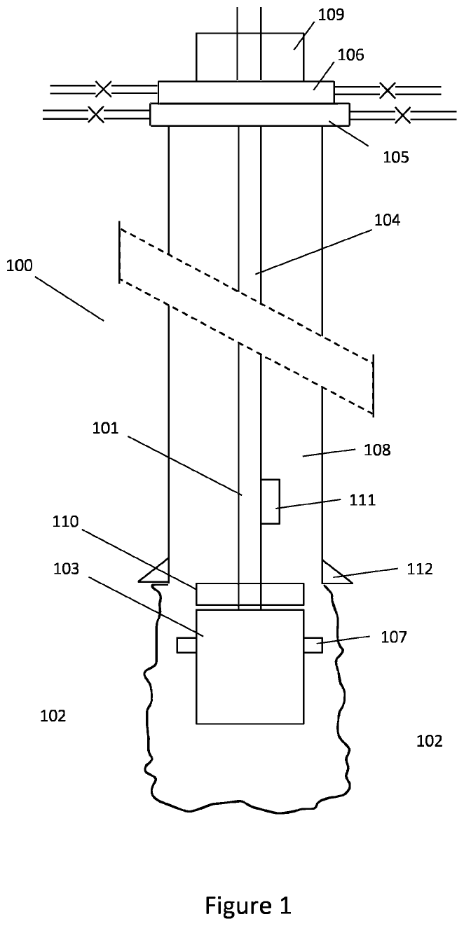

FIG. 1 shows an example of a heating system 101 in a well 100.

The heating system 101 is for producing syngas from hydrocarbon bearing rock formation 102. Heating system 101 has a heating device 103. In use, the heating device 103 is passed through well 100 in the hydrocarbon bearing rock formation 102 to an underground location within the hydrocarbon bearing rock formation and actuated at the underground location to heat the hydrocarbon bearing rock formation to produce syngas.

The well 100 has a depth of over 1000 ft. The well has a well head 105 at around 5000 psi with valved inlets and outlets and a blow-out preventer (BOP) 106 with valved inlets and outlets. Casing shoe 112 is provided at the bottom of the well annulus 108.

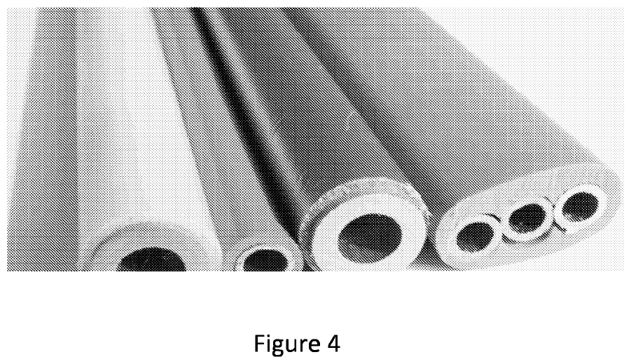

The heating system has control line 104 coupled to the heating device. The control line has one or more tubes encapsulated in a plastic-like material as shown by the example control lines in FIG. 4. The control line has a diameter of between 0.5″ and 3″, for example, around 1″.

The heating system has a sheave (not shown in FIG. 1), over which the control line passes above the well 100. The sheave has a diameter of at least 60 times the diameter of the control line. The control line passes over the sheave from a spool coupled to an anchor on which the control line is mounted. The anchor is a base filled with water.

As shown in FIG. 4, the control line may have multiple tubes. Each tube provides a passage, for example, a fluid supply passage for passing fluid to the underground location and/or a gas vent passage for collecting gas from the underground location and/or an electricity supply passage housing a conductor.

In the embodiment shown in FIG. 1, the control line has an inner tube within an outer tube such that the control line provides a first passage through the inner tube and a second passage through an annulus formed inside the outer tube, and outside of the inner tube. The first passage is a fluid supply passage configured to supply oxygenated gas to the heating device and the second passage is a gas vent passage configured to pass gas from the underground location, to the surface. The fluid supply passage has a one-way valve to ensure no backflow of gas.

In use, the oxygenated gas is supplied via the first passage of the control line when the heating device is activated and continues to be supplied while the heating device is producing heat.

Once the heating process is complete, or in the event of overheating or a safety issue, an inert gas is supplied via the fluid supply passage to extinguish combustion in the underground location.

Flexible fin 107 is coupled to the heating device, and extends radially outwards. The fin is attached to the heating device and is sacrificial.

In use, fluid is pumped into well annulus 108 behind fin 107 to urge the heating device 103 through the well to the underground location.

The heating system 101 has annular lubricator 109 which forms a pressure seal between the well, the well tubing, the well annulus or the wellhead and the outside environment and a packoff, the packoff configured to seal wellbore fluids and gasses inside the well while moving the control line into or out of the well.

Heat shield 110 is provided above the heating device 103. The heat shield is formed of a ceramic material and keeps the heat concentrated on the rock and reduces the heat escaping back up the well annulus.

Receptacle 111 contains a filter cartridge configured to separate hydrogen from syngas passing through the gas vent passage. The receptacle is coupled to the gas vent passage such that gas passing through the gas vent passage passes through the receptacle. Hydrogen is filtered from the syngas and passes back into the gas vent tube towards the surface and the remaining syngas is released into the surrounding rock formation. The filter includes a palladium or another catalyst and is located on the control line. The cartridge in receptacle 111 is latched and recoverable by mechanical or hydrostatic means. This means that the filter may be changed as required and the filter(s) can be changed from surface without pulling the heating device and control line out of the well.

The heating system also has a surface gas separation system which filters the gas collected by the gas vent passage. The system may also include a software evaluation system which calculates the composition of the syngas produced from monitored parameters in the well.

The heating device of FIG. 1 includes a thermite fuel and an initiator. The initiator is a magnesium strip which can be ignited by friction or electric charge.

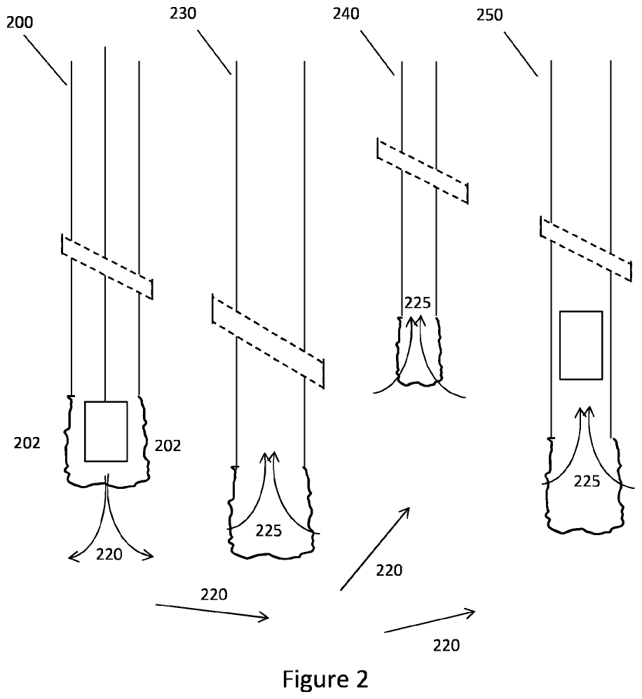

FIG. 2 shows an alternative system where gas is collected from secondary wells rather than or as well as through the control line. Heating well 200 has a heating system 201 operating to heat the surrounding hydrocarbon bearing rock formation 202. Heat, fluids and gasses 220 pass through the neighbouring rock formations and syngas 225 is collected via secondary or production wells 230, 240 and 250.

Production well 250 shows an example containing a filter receptacle 211 which filters the syngas to separate hydrogen from the remaining syngas. The filter is remotely changeable.

It will be understood that in other embodiments, another number of production and/or heating wells may be used and filter receptacles may be located in some or all of the production wells underground and/or at the surface.

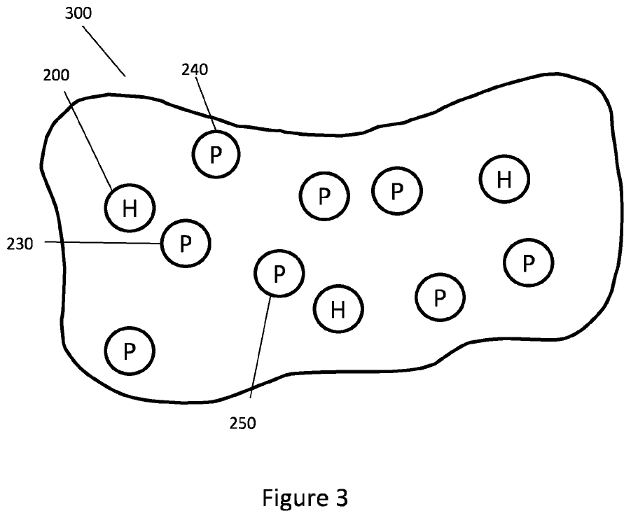

FIG. 3 shows an example of a top view of a syngas production area 300 with heating wells H and production wells P. Wells H and P may be oil or gas wells in an oil or gas field pattern. Heat may be applied between 200 and 1200 C. Fluid may be pumped between the wells to assist dissipation of heat.

Although particular embodiments of the disclosure have been disclosed herein in detail, this has been done by way of example and for the purposes of illustration only. The aforementioned embodiments are not intended to be limiting with respect to the scope of the appended claims.

It is contemplated by the inventors that various substitutions, alterations, and modifications may be made to the invention without departing from the scope of the invention as defined by the claims.

1. A method of producing syngas from a hydrocarbon bearing rock formation, the method comprising:
advancing a heating device through a well in the hydrocarbon bearing rock formation to an underground location within the hydrocarbon bearing rock formation; and
activating the heating device at the underground location to heat the hydrocarbon bearing rock formation to produce syngas.

2. A method according to claim 1, wherein advancing the heating device comprises advancing a control line coupled to the heating device through the well.

3. A method according to claim 2, wherein the heating device is coupled to a flexible fin extending radially outwards and wherein advancing the heating device through the well comprises pumping fluid into the well behind the fin to urge the heating device through the well towards the underground location.

4. A method according to claim 3, comprising determining when the heating device is at the underground location by monitoring the pressure of the fluid and detecting a decrease in pressure indicative of the heating device being located at the underground location.

5. A method according to claim 3, comprising determining when the heating device is at the underground location by monitoring the volume of fluid pumped.

6. A method according to claim 2, comprising supplying air, oxygen or other gasses to the underground location via the control line when the heating device is activated.

7. A method according to claim 6, comprising supplying air, oxygen or other gasses to the heating device after activating the heating device.

8. A method according to claim 2, wherein activating the heating device comprises supplying electricity to the heating device via an electrical conductor in the control line.

9. A method according to claim 2, comprising drawing gas generated by the heated rock formation through a passage in the control line.

10. A method according to claim 2, comprising drawing gas generated by the heated rock formation through a secondary well.

11. A method according to claim 9, wherein drawing the gas comprises using a vacuum.

12. A method according to claim 2, wherein the control line passes through a lubricator on top of the well head, the lubricator being configured to form a pressure seal between the well and the outside environment.

13. A method according to claim 2, wherein a heat shield is provided above the heating device.

14. A method of producing hydrogen, the method comprising: producing syngas using a method of claim 1, and filtering the syngas to extract hydrogen.

15. A method according to claim 14, wherein filtering the syngas to extract hydrogen is preceded by running a filter from the surface to the underground location by hydraulic or mechanical means.

16. A method according to claim 15, comprising securing the filter in position at the underground location.

17. A method according to claim 16, wherein securing the filter comprises latching the filter to a receptacle.

18. A method according to claim 15, comprising retrieving the filter from the underground location by hydraulic or mechanical means.

19. A method according to claim 1, wherein the heating device comprises a fuel and wherein activating the heating device comprises igniting the fuel.

20. A method as claimed in claim 1, wherein advancing the heating device comprises lowering the heating device into the well under gravity.

21. A method as claimed in claim 1, wherein the underground location is a void above the base of the well.

22. A heating system for producing syngas from a hydrocarbon bearing rock formation, the heating system comprising: a heating device passable through a well in the hydrocarbon bearing rock formation to an underground location within the hydrocarbon bearing rock formation; and actuatable at the underground location to heat the hydrocarbon bearing rock formation to produce syngas.

23. A heating system according to claim 22, the heating system further comprising a control line coupled to the heating device.

24. A heating system according to claim 23, the heating system further comprising a heat shield provided above the heating device.
